(19) United States
(12) Patent Application Publication
(10) Pub. No.: US 2023/0288660 A1
(43) Pub. Date: Sep. 14, 2023

(54) MICROLENS ARRANGEMENT AND MICRO-OPTICAL DEVICE

(71) Applicant: Siemens Energy Global GmbH & Co. KG, Munich, Bayern (DE)

(72) Inventor: Stefan Schuberth, Lichtenfels-Schney, Bavaria (DE)

(73) Assignee: Siemens Energy Global GmbH & Co. KG, Munich, Bayern (DE)

(21) Appl. No.: 18/020,928

(22) PCT Filed: Aug. 6, 2021
(86) PCT No.: PCT/EP2021/072080

§ 371 Date: Feb. 11, 2023

(30) Foreign Application Priority Data
Aug. 27, 2020 (DE) 10 2020 210 845.5

(51) Int. Cl. G02B 7/02

(52) U.S. Cl. CPC G02B 7/025

(57) ABSTRACT

A microlens arrangement and to a micro-optical device having a microlens arrangement. The microlens arrangement includes a microlens and a lens holder for the microlens, wherein the lens holder has a holding tube that has a tube slot, and the microlens is arranged within the holding tube.

### CROSS REFERENCE TO RELATED APPLICATIONS

This application is the US National Stage of International Application No. PCT/EP2021/072080 filed 6 Aug. 2021, and claims the benefit thereof. The International Application claims the benefit of German Application No. DE 10 2020 210 845.5 filed 27 Aug. 2020. All of the applications are incorporated by reference herein in their entirety.

### FIELD OF INVENTION

The invention relates to a microlens arrangement and to a micro-optical device having a microlens arrangement.

### BACKGROUND OF INVENTION

A microlens is used, for example, in order to couple light of a light source into an optical waveguide. In this case, for example, a light-emitting diode is used as the light source. With the microlens, the light of the light source is concentrated. This is often necessary because the light output by the light source is relatively low in intensity and/or highly divergent, that is to say it is radiated into a large solid angle and therefore needs to be concentrated. In such a case, concentrating the light with the microlens allows a sufficient light intensity of the light coupled into the optical waveguide.

In optical engineering, a microlens is for example arranged directly on or over a light-emitting face of a light source in order to collect light radiated by the light source from a solid angle which is as large as possible and couple it into an optical waveguide. Such a microlens may, for example, have a diameter of less than 0.3 mm. The adjustment of the microlens over the light source is intensive in terms of training, time and personnel, which greatly increases the production costs of a micro-optical device having a light source and a microlens.

### SUMMARY OF INVENTION

The object of the invention is to facilitate the adjustment of a microlens.

The object is achieved according to the invention by a microlens arrangement, by a micro-optical device and by a method having the features of the claims.

The dependent claims relate to advantageous configurations of the invention.

A microlens arrangement according to the invention comprises a microlens and a lens holder for the microlens, the lens holder having a holding tube which has a tube slot, and the microlens being arranged inside the holding tube.

In the microlens arrangement according to the invention, a microlens is thus arranged in a slotted holding tube of a lens holder. The microlens arrangement allows simple adjustment of the microlens over a light source by arranging the microlens inside the holding tube, which is arranged over the light source. The tube slot of the holding tube may in this case advantageously be used in order to fit the microlens into the holding tube, adjust a distance of the microlens from the light source and fasten the microlens on the holding tube, for example by adhesive bonding of the microlens to the holding tube. In addition, the holding tube may also be used to direct light of the light source to the microlens. The tube slot in the holding tube of the microlens arrangement may furthermore advantageously be used for guiding an electrical line, for example a bonding wire, through to the light source.

In one configuration of the microlens arrangement according to the invention, the tube slot runs over the entire tube length of the holding tube. In this way, the microlens may advantageously be positioned by the tube slot and fastened on the holding tube along the entire tube length of the holding tube.

In another configuration of the microlens arrangement according to the invention, the microlens has a diameter which corresponds to an inner diameter of the holding tube. In this way, the microlens may be clamped in the holding tube for the adjustment before it is fixed further, for example by adhesive bonding, on the holding tube. Furthermore, matching the diameter of the microlens to the inner diameter of the holding tube achieves the effect that light passing through the holding tube can be concentrated by the microlens over the entire inner diameter of the holding tube.

In another configuration of the microlens arrangement according to the invention, the microlens is adhesively bonded to the holding tube. By adhesive bonding of the microlens to the holding tube, a flexibly producible permanent connection of the microlens in the holding tube is made possible.

In another configuration of the microlens arrangement according to the invention, the holding tube is made from brass, aluminum or, for example by means of 3D printing, a plastic. Making the holding tube from brass or aluminum allows, in particular, simple adhesive bonding or (particularly in the case of using brass) soldering of the microlens to the holding tube. Making the holding tube from a plastic, in particular by means of 3D printing, advantageously allows simple and flexible configuration of the holding tube.

In another configuration of the microlens arrangement according to the invention, the holding tube is configured as a slotted hollow cylinder. For example, the tube slot runs parallel with respect to a cylinder axis of the holding tube. By virtue of a hollow cylindrical configuration of the holding tube, the holding tube has a constant inner diameter over its entire tube length. The microlens may thereby be arranged in the same way at each height of the holding tube and therefore at each distance from the light source inside the holding tube, so that the distance from the light source can be matched to the optical properties of the light source in order to concentrate optimally the light output by the light source. A tube slot in the holding tube, running parallel with respect to a cylinder axis of the holding tube, advantageously allows positioning, adjustment and fastening of the microlens along the cylinder axis of the holding tube without rotation of the instruments used therefor about the cylinder axis.

In another configuration of the microlens arrangement according to the invention, the lens holder has a base plate which is arranged on one end of the holding tube, closes the lens holder and has a base plate opening toward the tube interior of the holding tube. Furthermore, the base plate may have a base plate slot which extends from the base plate opening to the tube slot of the holding tube. For example, the base plate is made from brass, aluminum or, by means of 3D printing, a plastic.

A configuration of the microlens arrangement with a base plate simplifies the fastening of the microlens arrangement, for example by adhesive bonding or soldering of the base plate, because of the larger area of the base plate in comparison with the edges of the holding tube. A base plate opening in the base plate may be matched to the dimensions of a light source over which the microlens arrangement is arranged, and may therefore advantageously simplify the positioning of the microlens arrangement during its mounting. A base plate slot in the base plate may, for example, be used to position the microlens arrangement over a light source which is supplied with electrical energy via an electrical line, by the base plate slot being used as a recess through which this electrical line is guided during the positioning of the microlens arrangement. Making the base plate from brass or aluminum allows, in particular, simplified adhesive bonding or (particularly in the case in which brass is used) soldering of the base plate to the holding tube. Making the base plate from a plastic, in particular by means of 3D printing, advantageously allows simple and flexible configuration of the base plate.

A micro-optical device according to the invention comprises a carrier element, a die arranged on the carrier element, a light-emitting diode arranged on the die, and a microlens arrangement according to the invention, with the lens holder of the microlens arrangement being arranged on the carrier element and an end section of the holding tube running around the die.

A micro-optical device according to the invention allows simplified adjustment of a microlens over a light-emitting diode by arranging the microlens in the holding tube of a micro-optical device according to the invention. Further advantages of a micro-optical device according to the invention may be derived from the aforementioned advantages of a microlens arrangement according to the invention.

One configuration of the micro-optical device according to the invention has a bonding wire which is connected to the die and is guided through the tube slot of the holding tube.

The aforementioned configuration of the micro-optical device according to the invention takes into account the fact that a die having a light-emitting diode is often electrically contacted via a bonding wire. The tube slot in the holding tube of the microlens arrangement is in this case advantageously used for guiding the bonding wire through.

In another configuration of the micro-optical device according to the invention, the lens holder of the microlens arrangement has a base plate with a base plate opening, which corresponds to the die and is arranged around the die.

The aforementioned configuration of the micro-optical device according to the invention advantageously facilitates positioning of the microlens arrangement by arranging the die in the base plate opening of the base plate and thereby at the same time simplifies the adjustment of the microlens over the light-emitting diode.

In another configuration of the micro-optical device according to the invention, the lens holder of the microlens arrangement is adhesively bonded or soldered to the carrier element. In this way, the microlens arrangement is fixed on the carrier element in a simple and economical way.

In a method according to the invention for producing a microlens arrangement according to the invention, the microlens is clamped in the holding tube and subsequently adhesively bonded to the holding tube through the tube slot and/or directly on the tube slot.

### BRIEF DESCRIPTION OF THE DRAWINGS

The above-described properties, features and advantages of this invention, as well as the way in which they are achieved, will become more clearly and readily comprehensible in conjunction with the following description of exemplary embodiments, which will be explained in more detail in connection with the drawings, in which:

FIG. 1 shows a perspective representation of an exemplary embodiment of a micro-optical device,

FIG. 2 shows a plan view of the micro-optical device shown in FIG. 1,

FIG. 3 shows a perspective representation of the micro-optical device shown in FIG. 1 before mounting of the microlens arrangement,

FIG. 4 shows a plan view of an exemplary embodiment of a microlens arrangement,

FIG. 5 shows a base plate of a microlens arrangement.

### DETAILED DESCRIPTION OF INVENTION

Parts which correspond to one another are provided with the same references in the figures.

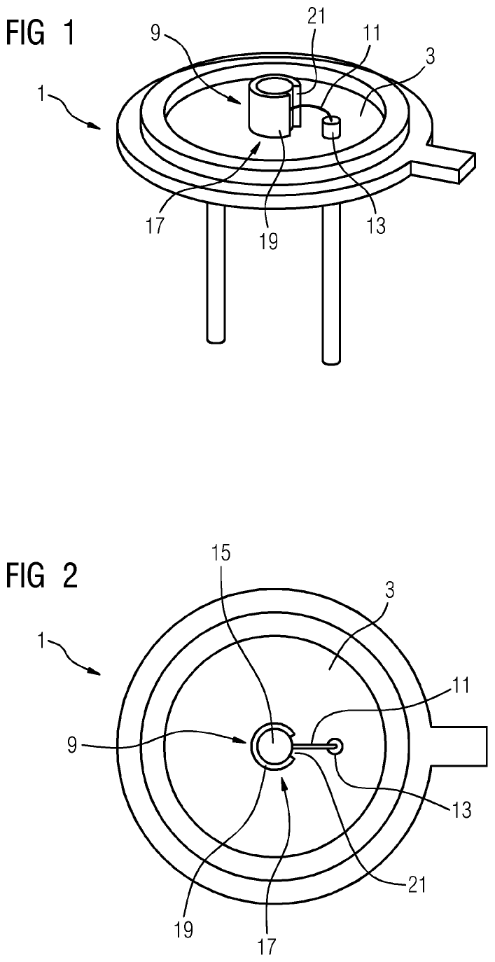

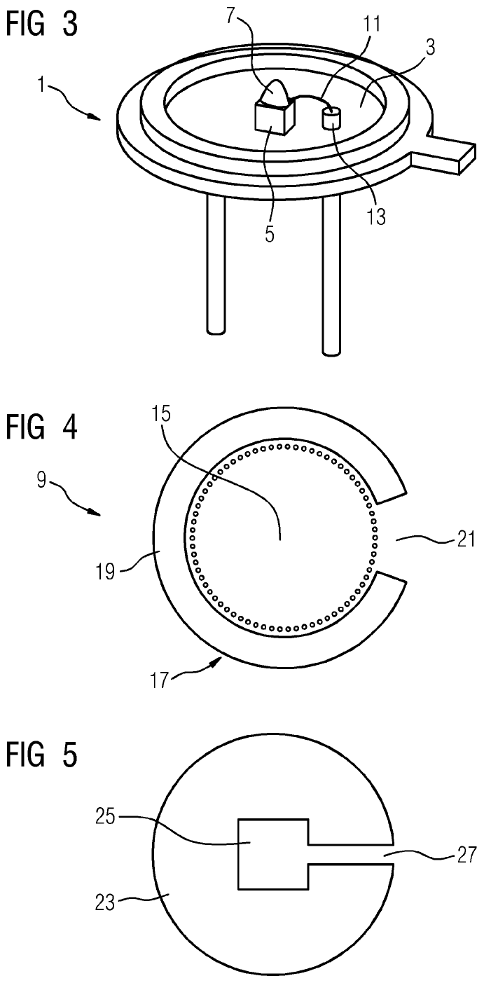

FIG. 1 (FIG. 1) and FIG. 2 (FIG. 2) show an exemplary embodiment of a micro-optical device 1 according to the invention. In this case, FIG. 1 shows a perspective representation of the micro-optical device 1 and FIG. 2 shows a plan view of the micro-optical device 1. The micro-optical device 1 comprises a carrier element 3, a die 5, a light-emitting diode 7 (see FIG. 3) and an exemplary embodiment of a microlens arrangement 9 according to the invention.

FIG. 3 (FIG. 3) shows a perspective representation of the micro-optical device 1 without the microlens arrangement 9, that is to say before mounting of the microlens arrangement 9. The die 5 is arranged on the carrier element 3. The light-emitting diode 7 is arranged on the die 5. The die 5 is connected by means of a bonding wire 11 to an electrical contact terminal 13 arranged on the carrier element 3.

FIG. 4 (FIG. 4) shows a plan view of the microlens arrangement 9. The microlens arrangement 9 comprises a microlens 15 and a lens holder 17 for the microlens 15. The lens holder 17 has a holding tube 19. The holding tube 19 is configured as a slotted hollow cylinder having a tube slot 21, which runs parallel with respect to a cylinder axis of the holding tube 19 over an entire tube length of the holding tube 19. For example, the holding tube 19 is made from brass, aluminum or, by means of 3D printing, from a plastic.

The microlens 15 is arranged inside the holding tube 19 and has a diameter which corresponds to an inner diameter of the holding tube 19. For example, the microlens 15 is adhesively bonded to the holding tube 19.

The lens holder 17 of the microlens arrangement 9 is arranged on the carrier element 3, with an end section of the holding tube 19 running around the die 5. For example, the lens holder 17 is adhesively bonded or soldered to the carrier element 3. The bonding wire 11 is guided through the tube slot 21 of the holding tube 19.

FIG. 5 (FIG. 5) shows an optional base plate 23 of the lens holder 17 of the microlens arrangement 9. The base plate 23 is arranged on an end of the holding tube 19 on the carrier element side and closes the lens holder 17 on the carrier element side. The base plate 23 has a base plate opening 25 toward the tube interior of the holding tube 19. The base plate opening 25 corresponds to the die 5 and is arranged around the die 5. Furthermore, the base plate 23 has a base plate slot 27 which extends from the base plate opening 25 to the tube slot 21 of the holding tube 19. For example, the base plate 23 is made from brass, aluminum or, by means of 3D printing, from a plastic.

During the production of the microlens arrangement 9, the microlens 15 is clamped in the holding tube 19 at a distance which is matched to the optical properties of the light-emitting diode 7 used, in order to concentrate optimally the light output by the light-emitting diode 7. Subsequently, the microlens 15 is adhesively bonded to the holding tube 19 through the tube slot 21 and/or directly to the tube slot 21. In the case of producing microlens arrangements 9 of the same type for light-emitting diodes 7 with the same optical properties, the microlenses 15 may be fixed in a preproduction step respectively at a predetermined distance, matched to the optical properties of the light-emitting diodes 7, from the light-emitting diode 7 in the holding tube 19. If the microlens arrangement 9 has a base plate 23, the base plate 23 is furthermore adhesively bonded or soldered to the holding tube 19.

During the production of the micro-optical device 1, the end of the lens holder 17 on the carrier element side is adhesively bonded or soldered onto the carrier element 3 around the die 5. If the microlens arrangement 9 does not have a base plate 23, the end of the holding tube 19 on the carrier element side is adhesively bonded or soldered onto the carrier element 3 around the die 5. If the microlens arrangement 9 does have a base plate 23, the base plate 23 is adhesively bonded or soldered onto the carrier element 3, in which case, during the positioning of the microlens arrangement 9, on the carrier element 3, the die 5 is guided through the base plate opening 25 of the base plate 23 and the bonding wire 11 is guided through the base plate slot 27 of the base plate 23.

Although the invention has been illustrated and described in detail by preferred exemplary embodiments, the invention is not restricted by the examples disclosed, and other variants may be derived therefrom by a person skilled in the art without departing from the protective scope of the invention.

1. A microlens arrangement, comprising:
a microlens, and
a lens holder for the microlens,
wherein the lens holder includes a holding tube with a tube slot, and
wherein the microlens is arranged inside the holding tube.

2. The microlens arrangement as claimed in claim 1,
wherein the tube slot runs over an entire tube length of the holding tube.

3. The microlens arrangement as claimed in claim 1,
wherein the microlens has a diameter which corresponds to an inner diameter of the holding tube.

4. The microlens arrangement as claimed in claim 1,
wherein the microlens is adhesively bonded to the holding tube.

5. The microlens arrangement as claimed in claim 1,
wherein the holding tube is made from brass, aluminum, or a plastic.

6. The microlens arrangement as claimed in claim 1,
wherein the holding tube is configured as a slotted hollow cylinder.

7. The microlens arrangement as claimed in claim 6,
wherein the tube slot runs parallel with respect to a cylinder axis of the holding tube.

8. The microlens arrangement as claimed in claim 1,
wherein the lens holder has a base plate which is arranged on one end of the holding tube, closes the lens holder and has a base plate opening toward the tube interior of the holding tube.

9. The microlens arrangement as claimed in claim 8,
wherein the base plate has a base plate slot which extends from the base plate opening to the tube slot of the holding tube.

10. The microlens arrangement as claimed in claim 8,
wherein the base plate is made from brass, aluminum, or a plastic.

11. A micro-optical device, comprising:
a carrier element,
a die arranged on the carrier element,
a light-emitting diode arranged on the die, and
a microlens arrangement configured as claimed in claim 1,
wherein the lens holder of the microlens arrangement is arranged on the carrier element and an end section of the holding tube runs around the die.

12. The micro-optical device as claimed in claim 11, further comprising:
a bonding wire which is connected to the die and is guided through the tube slot of the holding tube.

13. The micro-optical device as claimed in claim 11,
wherein a base plate opening of the base plate corresponds to the die and is arranged around the die.

14. The micro-optical device as claimed in claim 11,
wherein the lens holder of the microlens arrangement is adhesively bonded or soldered to the carrier element.

15. A method for producing a microlens arrangement configured as claimed in claim 1, the method comprising:
clamping the microlens in the holding tube and subsequently adhesively bonding the microlens to the holding tube through the tube slot and/or directly on the tube slot.

16. The microlens arrangement as claimed in claim 5,
wherein the holding tube is made of plastic via 3D printing.

17. The microlens arrangement as claimed in claim 10,
wherein the base plate is made of plastic via 3D printing.
